(19) United States
(12) Patent Application Publication
(10) Pub. No.: US 2010/0296200 A1
(43) Pub. Date: Nov. 25, 2010

(54) PERPENDICULAR MAGNETIC RECORDING MEDIUM AND MAGNETIC RECORDING/REPRODUCTION APPARATUS

(75) Inventor: Takeshi IWASAKI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/785,329

(22) Filed: May 21, 2010

(30) Foreign Application Priority Data
May 22, 2009 (JP) 2009-124419

(51) Int. Cl. G11B 5/56; G11B 5/62; G11B 5/73

(52) U.S. Cl. 360/294; 428/831; 428/831.2; G9B/5.201; G9B/5.233; G9B/5.283

(57) ABSTRACT

According to one embodiment, a multilayered nonmagnetic underlayer is provided under a perpendicular magnetic recording layer, which has a structure in which a nonmagnetic template layer consisting of ruthenium and silicon is formed between a first nonmagnetic underlayer consisting of one of ruthenium and a first ruthenium alloy sputtered in an inert gas ambient, and a second nonmagnetic underlayer consisting of one of ruthenium and a second ruthenium alloy sputtered in an inert gas ambient at a pressure higher than that when sputtering the first nonmagnetic underlayer.

### CROSS-REFERENCE TO RELATED APPLICATIONS

This application is based upon and claims the benefit of priority from Japanese Patent Application No. 2009-124419, filed May 22, 2009, the entire contents of which are incorporated herein by reference.

### FIELD

Embodiments described herein relate generally to a perpendicular magnetic recording medium for use in, e.g., a hard disk drive using the magnetic recording technique, and a magnetic recording/reproduction apparatus.

### BACKGROUND

Recently, in keeping with demand for a large-capacity hard disk drive, recording bit size continues to decrease as recording density increases. To form a large-capacity hard disk medium, it is necessary not only to decrease the recording bit size, but also to improve the recording/reproduction characteristic, i.e., to reduce noise produced by the medium. The main cause of the medium noise is considered to be a zigzag magnetic domain wall in the bit boundary. One method of reducing the noise produced by the bit boundary is to form a better defined recording bit boundary. Since this reduces the magnetic interaction between recording bits, recording and reproduction can accurately be performed on each individual recording bit.

An example of the means for improving the recording/reproduction characteristic is a technique disclosed in Jpn. Pat. Appln. KOKAI Publication No. 2003-77122. In this technique, in a perpendicular magnetic recording medium obtained by sequentially stacking at least a nonmagnetic underlayer, magnetic layer, and protective film on a nonmagnetic substrate, the magnetic layer consists of ferromagnetic crystal grains and a nonmagnetic grain boundary mainly containing an oxide, the nonmagnetic underlayer consists of a metal or alloy having the hexagonal closest packed crystal structure, and a seed layer consisting of a metal or alloy having the face-centered cubic crystal structure is formed between the nonmagnetic underlayer and nonmagnetic substrate. Especially in this technique, the seed layer consists of a metal selected from Cu, Au, Pd, Pt, and Ir, an alloy containing at least one of Cu, Au, Pd, Pt, and Ir, or an alloy containing Ni and Fe. This technique has attempted to orient the nonmagnetic underlayer having the hexagonal closest packed structure formed on the seed layer in the (002) plane by orienting the (111) plane as the closest packed plane of the face-centered cubic structure as the seed layer. This also makes it possible to improve the crystal orientation of the recording layer having the same hexagonal closest packed structure as that of the nonmagnetic underlayer, and obtain a perpendicular magnetic recording medium superior in magnetic characteristics. However, the crystal orientation improves when using a crystalline seed layer having the face-centered cubic structure, but the crystal grains become difficult to make smaller because the grain size of the seed layer is reflected on the nonmagnetic underlayer.

Also, as disclosed in, e.g., Jpn. Pat. Appln. KOKAI Publication No. 2004-327006, there is another technique in which at least a soft magnetic underlayer, first nonmagnetic underlayer, second nonmagnetic underlayer, perpendicular magnetic recording film, and protective film are formed on a nonmagnetic substrate, the first nonmagnetic underlayer consists of Pt, Pd, or an alloy containing at least one of Pt and Pd, and the second nonmagnetic underlayer consists of Ru or an Ru alloy. This technique has attempted to improve the recording/reproduction characteristic and increase the thermal decay resistance by this arrangement. In this technique, in particular, a Pt alloy or Pd alloy obtained by adding another element to Pt or Pd can be used as the first nonmagnetic underlayer in order to make the crystal grains smaller. The technique has enumerated B, C, P, Si, Al, Cr, Co, Ta, W, Pr, Nd, Sm, and the like as favorable additive elements, and has attempted to improve the crystallinity of the second nonmagnetic underlayer and magnetic recording layer by adding particularly C.

Unfortunately, although the crystal orientation and recording/reproduction characteristic improve by adding an additive to Pt or Pd, the first nonmagnetic underlayer has a grain size and maintains the shape of a crystal grain as described in the embodiments. In this case, the grain size of the first nonmagnetic underlayer is a restriction and makes it difficult to further decrease the grain size of the magnetic recording layer.

### BRIEF DESCRIPTION OF THE DRAWINGS

FIG. 1 is a sectional view showing the arrangement of a perpendicular magnetic recording medium according to an embodiment of the present invention;

FIG. 2 is a sectional view exemplarily showing the arrangement of a perpendicular magnetic recording medium according to an embodiment of the present invention; and

FIG. 3 is a partially exploded perspective view showing an example of a magnetic recording/reproduction apparatus of the present invention.

### DETAILED DESCRIPTION

In general, according to one embodiment, a perpendicular magnetic recording medium is provided which includes

a nonmagnetic substrate,

at least one soft magnetic layer formed on the nonmagnetic substrate,

a multilayered nonmagnetic underlayer formed on the soft magnetic layer, and

a perpendicular magnetic recording layer formed on the nonmagnetic underlayer,

wherein the multilayered nonmagnetic underlayer has a structure in which a nonmagnetic template layer consisting of ruthenium and silicon is formed between a first nonmagnetic underlayer consisting of one of ruthenium and a first ruthenium alloy sputtered in an inert gas ambient, and a second nonmagnetic underlayer consisting of one of ruthenium and a second ruthenium alloy sputtered in an inert gas ambient at a pressure higher than that when sputtering the first nonmagnetic underlayer.

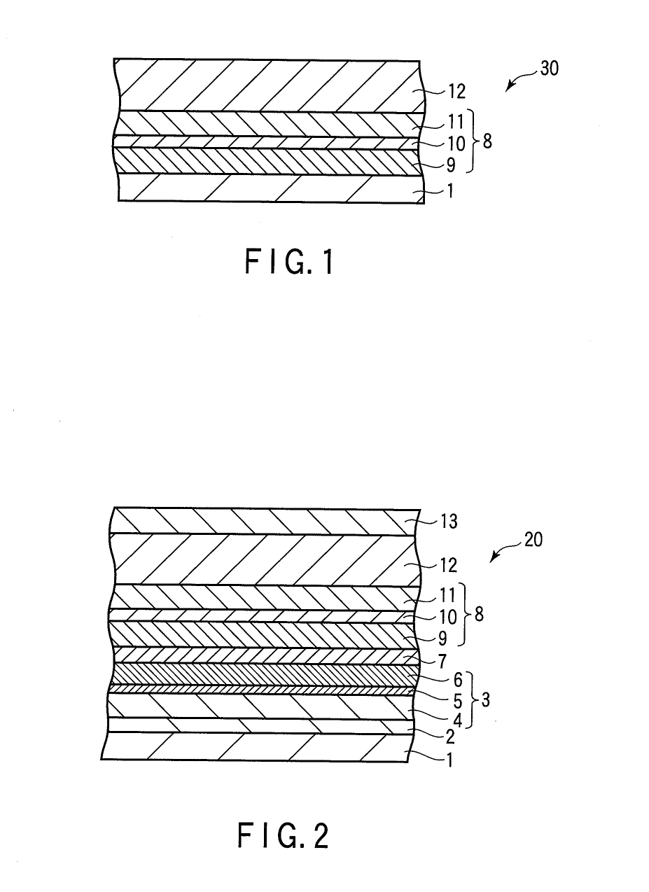

FIG. 1 is a sectional view showing the arrangement of a perpendicular magnetic recording medium according to an embodiment of the present invention.

As shown in FIG. 1, a perpendicular magnetic recording medium 30 has an arrangement in which a multilayered underlayer 8 and perpendicular magnetic recording layer 12 are sequentially formed on a nonmagnetic substrate 3. As the multilayered underlayer 8, a first nonmagnetic underlayer 9, nonmagnetic template layer 10, and second nonmagnetic underlayer 11 are sequentially formed on the nonmagnetic substrate 3.

The first and second nonmagnetic underlayers consist of ruthenium or a ruthenium alloy. The first and second nonmagnetic underlayers can have the same composition or different compositions.

Even when the first and second nonmagnetic underlayers have the same composition, their crystal states become different because the pressures are different when performing sputtering in an inert gas. When performing sputtering in a low-pressure inert gas, an underlayer having high-density, high-crystallinity crystal grains is obtained. On the other hand, when performing sputtering in a high-pressure inert gas, an underlayer having well defined crystal grains and a well defined grain boundary is obtained.

The inert gas is selected from the group consisting of argon, neon, krypton, and xenon.

The nonmagnetic template layer consists of ruthenium and silicon. The nonmagnetic template layer used in the present invention consists of columnar grains of ruthenium or a ruthenium alloy, and a silicon grain boundary formed to surround the columnar ruthenium or ruthenium-alloy grains. This nonmagnetic template layer has a very good grain size distribution, and can have a grain size distribution whose standard deviation is 20% or less. By forming this nonmagnetic template layer between the first and second nonmagnetic underlayers consisting of ruthenium or a ruthenium alloy, it is possible to greatly improve the grain size distribution of the second nonmagnetic underlayer consisting of ruthenium or a ruthenium alloy. This also improves the grains size distribution of the perpendicular magnetic recording layer formed on the second nonmagnetic underlayer. Consequently, the recording/reproduction characteristic greatly improves, and a perpendicular magnetic recording medium capable of high-density recording can be obtained.

FIG. 2 is a sectional view exemplarily showing the arrangement of a perpendicular magnetic recording medium according to an embodiment of the present invention.

Referring to FIG. 2, a perpendicular magnetic recording medium 20 has an arrangement in which an adhesive layer 2, soft magnetic backing layer 3, orientation control layer 7, underlayer 8, perpendicular magnetic recording layer 12, protective layer 13, and lubricating layer (not shown) are sequentially stacked on a nonmagnetic substrate 1. Soft magnetic backing layer 3 includes first soft magnetic layer 4, magnetism control layer 5, and second soft magnetic layer 6. The underlayer 8 is a stack of a first underlayer 9, nonmagnetic template layer 10, and second nonmagnetic underlayer 11.

As the nonmagnetic substrate 1, it is possible to use a metal substrate consisting of a metal material such as aluminum or an aluminum alloy. Alternatively, it is possible to use a non-metal substrate consisting of a non-metal material such as glass, ceramic, silicon, silicon carbide, or carbon. Examples of the glass material are amorphous glass and crystallized glass. As the amorphous glass, it is possible to use general-purpose soda lime glass or aluminosilicate glass. Also, lithium-based crystallized glass can be used as the crystallized glass.

The nonmagnetic substrate 1 can have an average surface roughness (Ra) of 0.8 nm or less, and can also have an Ra of 0 to 0.4 nm. When the Ra is small, it is possible to improve the crystal orientation of the interlayer 8 and perpendicular magnetic recording layer 9, and improve the recording/reproduction characteristic. Also, this often enables low floating of a magnetic head, which is necessary when performing high-density recording. The nonmagnetic substrate 1 can have a surface micro-undulation (Wa) of 0 to 0.3 nm, and can also have a Wa of 0.25 nm. When the Wa is small, a magnetic head can be used by low floating.

The adhesive layer 2 can have an amorphous structure. When manufacturing a magnetic recording medium by sputtering or the like, the substrate and magnetic recording medium raise their temperatures and thermally expand when heated. Since the thermal expansion coefficients of a substrate and thin metal film are generally different, a stress is induced in the substrate interface. If the adhesive layer 2 has a crystal structure, micro-cracks are produced in the crystal structure when absorbing the stress in the substrate interface, and corrosion caused by the components of the substrate, adsorbed water, or the like may enter the medium from these micro-cracks. When the adhesive layer 2 has an amorphous structure, the stress can be absorbed without producing cracks and the like in a crystal structure. Since this eliminates unstable portions or portions different in density, the corrosion resistance can be increased.

The soft magnetic backing layer 3 has two soft magnetic layers, i.e., the first soft magnetic layer 4 and second soft magnetic layer 6, and the magnetism control layer 5 formed between them. The magnetism control layer 5 controls the magnetic coupling between the first soft magnetic layer 4 and second soft magnetic layer 6. The magnetic coupling is normally antiferromagnetic coupling. This arrangement makes it possible to increase the resistance against an external magnetic field. Since the soft magnetic backing layer 3 having high permeability is formed, a so-called, double-layered perpendicular magnetic recording medium having the perpendicular magnetic recording layer on the soft magnetic backing layer is obtained. In this double-layered perpendicular magnetic recording medium, the soft magnetic backing layer horizontally passes a recording magnetic field from a magnetic head for magnetizing the perpendicular magnetic recording layer, and returns the magnetic field toward the magnetic head, i.e., performs a part of the function of the magnetic head. The soft magnetic recording layer makes it possible to apply a sufficient steep perpendicular magnetic field to the magnetic field recording layer, thereby increasing the recording/reproduction efficiency. The first soft magnetic layer 4 and second soft magnetic layer 6 can consist of, e.g., a CoZrNb alloy, CoTaZr alloy, FeCoB alloy, CoFeAl alloy, or CoAlCr alloy. A saturation magnetic flux density Bs of CoZrNb can be 1.1 T or more. The Bs of CoTaZr can be 1.4 to 1.8 T. By using these materials as the first soft magnetic layer 4 and second soft magnetic layer 6, it is possible to increase the saturation magnetic flux density and further improve the recording/reproduction characteristic. The film thickness of the soft magnetic backing layer including the first soft magnetic layer 4, magnetism control layer 5, and second soft magnetic layer 6 can be, e.g., 20 to 60 nm. If the film thickness of the soft magnetic backing layer is less than 20 nm, the magnetic flux from the head cannot be well absorbed. This often makes data write insufficient, and deteriorates the recording/reproduction characteristic. If the film thickness of the soft magnetic backing layer exceeds 60 nm, the flatness worsens, and the deposition time increases. This often significantly decreases the productivity. The first soft magnetic layer 4 and second soft magnetic layer 6 can have an amorphous structure. An amorphous structure can prevent the increase in Ra, reduce the floating amount of the magnetic head, and further increase the density.

The magnetism control layer 5 can consist of an alloy of, e.g., Ru, Pt, Pd, or Cu. Ru is particularly usable. The thickness of the magnetism control layer 5 can control the magnetic coupling between the first soft magnetic layer 4 and second soft magnetic layer 6. The magnetism control layer 5 can have a thickness of 0.5 to 1.2 nm, and can also have a thickness of 0.6 to 0.8 nm. When the thickness falls within this range, the first soft magnetic layer 4 and second soft magnetic layer 6 antiferromagnetically couple with each other. This makes it possible to increase the external magnetic field resistance of the magnetic recording medium.

The orientation control layer 7 controls the crystal orientation and crystal grain sizes of the underlayer 8 and perpendicular magnetic recording layer 12. As the orientation control layer 7, it is possible to use any of, e.g., an Ni alloy, Pt alloy, Pd alloy, Ta alloy, Cr alloy, Si alloy, and Cu alloy. These alloys can improve the crystal orientation and decrease the crystal grain size. It is also possible to add a predetermined element in order to improve the crystal lattice size matching with the underlayer 8. Examples of an element to be added to decrease the crystal size are particularly B, Mn, Al, Si oxide, and Ti oxide. Examples of an element to be added to improve the crystal lattice size matching with the underlayer 8 are Ru, Pt, W, Mo, Ta, Nb, and Ti. The film thickness of the orientation control layer 7 can be 1 to 10 nm. If the film thickness of the orientation control layer 7 is less than 1 nm, the effect as the orientation control layer becomes unsatisfactory, and the grain size decreasing effect cannot be obtained. In addition, the crystal orientation tends to worsen. Also, if the film thickness of the orientation control layer 7 exceeds 10 nm, a spacing loss occurs, and the crystal grain size often increases. Furthermore, the orientation control layer 7 can be formed by a plurality of layers instead of a single layer. In this case, the film thickness of the whole orientation control layer can be 2 to 15 nm. If the film thickness is 2 nm or less, the effect as the orientation control layer often becomes unsatisfactory. If the film thickness of the whole orientation control layer exceeds 15 nm, the spacing loss cannot be ignored any longer, and the recording/reproduction characteristic worsens.

As the underlayer 8, Ru or an Ru alloy can be used. Examples of the Ru alloy are Ru—Cr, Ru—Co, Ru—Mn, Ru—SiO₂, Ru—TiO₂, Ru—TiOₓ, Ru—B, and Ru—C. Among these alloys, it is possible to use Ru—Cr capable of achieving high crystallinity. Also, the underlayer 8 can have a double-layered structure such as the first nonmagnetic underlayer 9 and second nonmagnetic underlayer 10. In this structure, the first nonmagnetic underlayer 9 can have a relatively high density and high crystallinity. For example, the first nonmagnetic underlayer 9 having a high density and high crystallinity can be formed by performing sputtering at a low Ar pressure of 1 Pa or less. The second nonmagnetic underlayer 10 can have crystal grains and a grain boundary. For example, the second nonmagnetic underlayer 10 having well defined crystals and a well defined grain boundary can be formed by performing sputtering at a high Ar pressure of 5 Pa or more. The underlayer 8 can have a film thickness of 5 to 24 nm, and can also have a film thickness of 5 to 16 nm. When the film thickness of the underlayer 8 is small, the distance between a magnetic head and the soft magnetic backing layer 3 decreases. This makes it possible to steepen the magnetic flux from the magnetic head, and improve the easiness of signal write. If the film thickness of the underlayer 8 is less than 5 nm, the crystal orientation tends to worsen. On the other hand, if the film thickness of the underlayer 8 is 24 nm or more, a spacing loss occurs, and the recording/reproduction characteristic often worsens.

The nonmagnetic template layer 11 is formed as a grain size distribution template between the first nonmagnetic underlayer 9 and second nonmagnetic underlayer 10. An Ru—Si alloy can be used as the nonmagnetic template layer 11. The Ru—Si alloy is used because the underlayer 8 consists of Ru or an Ru alloy, and the Ru—Si alloy has a well defined grain-grain boundary structure consisting of Ru grains and an Si grain boundary, and has a superior grain size distribution. To use the nonmagnetic template layer 11 as a grain size distribution template layer, the nonmagnetic template layer 11 must have a good grain size distribution, and the distribution can have a standard deviation of 20% or less. Accordingly, it is possible to greatly improve the grain size distributions of the second nonmagnetic underlayer and perpendicular magnetic recording layer 12 to be formed on the nonmagnetic template layer 11. The film thickness of the nonmagnetic template layer 11 can be 1 to 5 nm. If the film thickness of the nonmagnetic template layer is less than 1 nm or larger than 5 nm, the crystal orientation often worsens.

The perpendicular magnetic recording layer 12 has the axis of easy magnetization perpendicular to the substrate surface. Also, the perpendicular magnetic recording layer 12 is processed into a DTR or BPM. As main elements forming the perpendicular magnetic recording layer 12, at least Co and Pt are contained, and it is also possible to add an oxide, Cr, B, Cu, Ta, Zr, or Ru in order to, e.g., improve the signal-to-noise ratio. Examples of the oxide to be added to the perpendicular magnetic recording layer 12 are SiO₂, SiO, Cr₂O₃, CoO, Co₃O₄, Ta₂O₅, and TiO₂. The content of the oxide can be 7 to 15 mol %. If the content of the oxide is less than 7 mol %, the division between the magnetic grains becomes insufficient, and this often makes the signal-to-noise ratio unsatisfactory. If the content of the oxide exceeds 15 mol %, it often becomes impossible to obtain a coercive force corresponding to a high recording density. The nuclear magnetism generation energy (-Hn) of the perpendicular magnetic recording layer 12 can be 1.5 kOe or more. If -Hn is less than 1.5 kOe, thermal decay tends to occur. The perpendicular magnetic recording layer 12 can have a film thickness of 6 to 20 nm. When the thickness of the perpendicular magnetic recording layer 12 consisting of an oxide granular layer falls within this range, a sufficient output can be secured, and the overwrite (OW) characteristic does not easily worsen. The perpendicular magnetic recording layer 12 can have a single-layered structure, and can also have a structure including two or more layers consisting of materials having different compositions. In particular, the perpendicular magnetic recording layer 12 can have a structure in which layers containing no oxide are sequentially stacked on a layer containing an oxide. The protective layer 13 prevents corrosion of the perpendicular magnetic recording layer 12, and also prevents damage to the medium surface when a magnetic head comes into contact with the medium. Conventionally known materials can be used as the protective layer 13. For example, it is possible to use materials containing C, SiO₂, and ZrO₂. Also, the film thickness of the protective layer 13 can be 1 to 5 nm. When the film thickness of the protective layer 13 is 1 to 5 nm, the distance between a magnetic head and the medium can be decreased, so a high recording density is possible. C can be classified into sp²-bonded carbon (graphite) and sp³-bonded carbon (diamond). Among amorphous carbon containing both sp²-bonded carbon and sp³-bonded carbon, diamond-like carbon (DLC) having a high sp³-bonded carbon ratio is useful from the viewpoint of durability and corrosion resistance. A DLC film can be formed by chemical vapor deposition (CVD). CVD excites and decomposes a source gas in a plasma, thereby producing DLC by a chemical reaction.

A lubricating agent (not shown) can be formed on the protective film 13.

Note that as the lubricating agent (not shown), it is possible to use any conventionally known material, e.g., perfluoropolyether, fluorinated alcohol, or fluorinated carboxylic acid.

As explained above, the magnetic recording medium 20 of this embodiment has the structure in which the adhesive layer 2, the soft magnetic backing layer 3, the orientation control layer 7, the underlayer 8 the perpendicular magnetic recording layer 12, the protective layer 13, and the lubricating layer (not shown) are stacked in this order on the nonmagnetic substrate 1. The soft magnetic backing layer 3 includes the first soft magnetic layer 4, the magnetism control layer 5, the second soft magnetic layer 6, and the underlayer 8 includes the first nonmagnetic underlayer 9, second nonmagnetic underlayer 10, and nonmagnetic template layer 11.

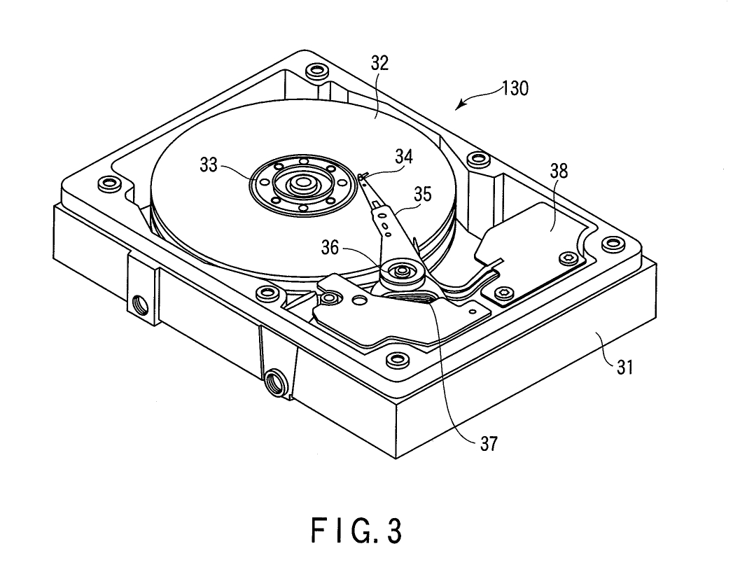

FIG. 3 is a partially exploded perspective view showing an example of a magnetic recording/reproduction apparatus of the present invention.

As shown in FIG. 3, a perpendicular magnetic recording apparatus 130 of the present invention has a rectangular boxy housing 31 having an open upper end, and a top cover (not shown) that is screwed to the housing 31 by a plurality of screws and closes the upper-end opening of the housing.

The housing 31 accommodates, e.g., a perpendicular magnetic recording medium 32 according to the present invention, a spindle motor 33 as a driving means for supporting and rotating the perpendicular magnetic recording medium 32, a magnetic head 34 for performing recording and reproduction of magnetic signals on the magnetic recording medium 32, a head actuator 35 that has a suspension on the distal end of which the magnetic head 34 is mounted, and supports the magnetic head 34 such that it can move over the perpendicular magnetic recording medium 32, a rotating shaft 36 for rotatably supporting the head actuator 35, a voice coil motor 37 for rotating and positioning the head actuator 35 via the rotating shaft 36, and a head amplifier circuit 38.

The present invention will be explained in more detail below by way of its examples.

Hereafter atomic % is written as at %.

### Example 1

A glass substrate (amorphous substrate MEL3 2.5 inches in diameter manufactured by MYG) was placed in a deposition chamber of a DC magnetron sputtering apparatus (C-3010 manufactured by Anelva), and the deposition chamber was evacuated until the vacuum degree reached 1×10⁻⁵ Pa. After that, Ar was supplied to set the internal pressure of the deposition chamber at 0.8 Pa, and an 8-nm-thick Cr-40 at % Ti film as an adhesive layer, a 20-nm-thick Co-5 at % Zr-4 at % Nb film as a first soft magnetic layer, a 0.6-nm-thick Ru film, and a 20-nm-thick Co-5 at % Zr-4 at % Nb film as a second soft magnetic layer were stacked on the substrate, thereby forming a soft magnetic backing layer. The crystal structure of the adhesive layer and each soft magnetic layer was found to be an amorphous structure by an X-ray diffraction apparatus.

Then, a 5-nm-thick Ni-8 at % W film as an orientation control layer, an 8-nm-thick Ru film as a first nonmagnetic underlayer, and a 3-nm-thick Ru-20 at % Si film as a nonmagnetic template layer were formed. After that, Ar was supplied by setting the internal pressure of the deposition chamber at 6 Pa, and a 6-nm-thick Ru film was formed as a second nonmagnetic underlayer. Subsequently, Ar was supplied by setting the internal pressure of the deposition chamber at 3 Pa, and a 12-nm-thick Co-20 at % Cr-18 at % Pt-10 mol % SiO₂ film as a first perpendicular magnetic recording layer was formed as a perpendicular magnetic recording layer. Then, Ar was supplied by setting the internal pressure of the deposition chamber at 0.8 Pa, and a 6-nm-thick Co-18 at % Cr-14 at % Pt-3 at % B film as a second perpendicular magnetic recording layer was formed. After that, a 4-nm-thick DLC protective layer was formed by CVD, and a lubricating film consisting of perfluoroether was formed by dipping, thereby obtaining a perpendicular magnetic recording medium.

### Comparative Example 1

A magnetic recording medium of Comparative Example 1 was manufactured following the same procedures as in Example 1 except that no nonmagnetic template layer was formed.

### Comparative Example 2

A magnetic recording medium of Comparative Example 2 was manufactured following the same procedures as in Example 1 except that a nonmagnetic template layer was formed not between first and second nonmagnetic underlayers but between a second soft magnetic layer and orientation control layer.

### Comparative Example 3

A magnetic recording medium of Comparative Example 3 was manufactured following the same procedures as in Example 1 except that a nonmagnetic template layer was formed not between first and second nonmagnetic underlayers but between an orientation control layer and the first nonmagnetic underlayer.

### Comparative Example 4

A magnetic recording medium of Comparative Example 4 was manufactured following the same procedures as in Example 1 except that a nonmagnetic template layer was formed not between first and second nonmagnetic underlayers but between the second nonmagnetic underlayer and a perpendicular magnetic recording layer.

### Comparative Example 5

A magnetic recording medium of Comparative Example 5 was manufactured following the same procedures as in Example 1 except that no nonmagnetic template layer was formed and an entire first nonmagnetic underlayer was changed to Ru-20 at % Si.

### Comparative Example 6

A magnetic recording medium of Comparative Example 6 was manufactured following the same procedures as in Example 1 except that no nonmagnetic template layer was formed and an entire second nonmagnetic underlayer was changed to Ru-20 at % Si.

### Comparative Example 7

A magnetic recording medium of Comparative Example 7 was manufactured following the same procedures as in Example 1 except that no nonmagnetic template layer was formed and both first and second nonmagnetic underlayers were changed to Ru-20 at % Si.

### Comparative Example 8

A magnetic recording medium of Comparative Example 8 was manufactured following the same procedures as in Example 1 except that no nonmagnetic template layer was formed and an entire first nonmagnetic underlayer was changed to Ru-10 mol % SiO₂.

### Comparative Example 9

A magnetic recording medium of Comparative Example 9 was manufactured following the same procedures as in Example 1 except that no nonmagnetic template layer was formed and an entire second nonmagnetic underlayer was changed to Ru-10 mol % SiO₂.

### Comparative Example 10

A magnetic recording medium of Comparative Example 10 was manufactured following the same procedures as in Example 1 except that no nonmagnetic template layer was formed and both first and second nonmagnetic underlayers were changed to Ru-10 mol % SiO₂.

### Comparative Example 11

A magnetic recording medium of Comparative Example 11 was manufactured following the same procedures as in Example 1 except that 3-nm-thick Ru-10 mol % SiO₂ was used instead of Ru-20 at % Si as a nonmagnetic template layer.

### Comparative Example 12

A magnetic recording medium of Comparative Example 12 was manufactured following the same procedures as in Example 1 except that 3-nm-thick Ru-30 at % Cr was used instead of Ru-20 at % Si as a nonmagnetic template layer.

First, transmission electron microscope (TEM) measurements were performed on the perpendicular magnetic recording layers of the obtained perpendicular magnetic recording media of Example 1 and Comparative Examples 1 to 12, thereby checking the grain size distributions of the crystal grains in the second nonmagnetic underlayers and perpendicular magnetic recording layers. The grain size distribution of each layer was evaluated by the following procedure. First, among planar TEM images at magnifications of ×500,000 to ×2,000,000, an arbitrary image containing at least 100 grains was input as image information to a computer. By processing this image information, the contour of each individual crystal grain was extracted, and the number of pixels surrounded by the contour was checked. The obtained number of pixels was converted into an area by being divided by the number of pixels per unit area, thereby obtaining an area occupied by each crystal grain. Then, a diameter when the crystal grain was regarded as a circle was calculated as a crystal grain size from the area of each crystal grain, and the average value and standard deviation of the crystal grain sizes were calculated.

Also, the recording/reproduction characteristics of the magnetic recording media of Example 1 and Comparative Examples 1 to 12 were evaluated. The recording/reproduction characteristics were evaluated by using a head having a shielded magnetic pole as a single magnetic pole with a shield in a write unit, and a TMR element in a read unit. The measurements were performed by setting the condition of the recording frequency at a linear recording density of 1,700 kBPI. Note that the shield has a function of converging the magnetic flux output from the magnetic head.

Tables 1-1 and 1-2 below show the evaluation results of the magnetic recording media of Example 1 and Comparative Examples 1 to 12.

TABLE 1-1

| | | Orientation | First nonmagnetic | Nonmagnetic |
|---|---|---|---|---|
| | | control layer | underlayer | template layer |
| Example 1 | | NiW | Ru | Ru-20 at % Si |
| Compar- | 1 | NiW | Ru | — |
| ative | 2 | Ru-20 at % | Ru | — |
| Example | | Si/NiW | | |
| | 3 | NiW | Ru-20 at % Si/Ru | — |
| | 4 | NiW | Ru | — |
| | 5 | NiW | Ru-20 at % Si | — |
| | 6 | NiW | Ru | — |
| | 7 | NiW | Ru-20 at % Si | — |
| | 8 | NiW | Ru-10 mol % SiO₂ | — |
| | 9 | NiW | Ru | — |
| | 10 | NiW | Ru-10 mol % SiO₂ | — |
| | 11 | NiW | Ru | Ru-10 mol % SiO₂ |
| | 12 | NiW | Ru | Ru-30 at % Cr |

TABLE 1-2

| | | Second | | Standard |
|---|---|---|---|---|
| | | nonmagnetic | SNR | deviation |
| | | underlayer | (dB) | (%) |
| Example 1 | | Ru | 27.5 | 14 |
| Comparative | 1 | Ru | 22.1 | 21 |
| Example | 2 | Ru | 18.3 | 21 |
| | 3 | Ru | 17.3 | 24 |
| | 4 | Ru/Ru-20 at % Si | 15.8 | 25 |
| | 5 | Ru | 8.3 | 30 |
| | 6 | Ru-20 at % Si | 9.5 | 32 |
| | 7 | Ru-20 at % Si | 7.8 | 35 |
| | 8 | Ru | 10.3 | 40 |
| | 9 | Ru-10 mol % SiO₂ | 11.2 | 38 |
| | 10 | Ru-10 mol % SiO₂ | 5.1 | 45 |
| | 11 | Ru | 17.3 | 29 |
| | 12 | Ru | 21.2 | 23 |

As shown in Tables 1-1 and 1-2, the magnetic recording medium of Example 1 was superior to those of Comparative Examples 1 to 12 in grain size distribution standard deviations and recording/reproduction characteristics.

### Example 2

Magnetic recording media of Example 2 were manufactured following the same procedures as in Example 1 except that the pressures were changed when depositing first and second nonmagnetic underlayers.

Table 2 below shows the evaluation results of the magnetic recording media of Example 2.

TABLE 2

| | Ar pressure (Pa) when depositing second nonmagnetic underlayer | | | | | | | | | |
|---|---|---|---|---|---|---|---|---|---|---|
| | | 0.1 | 0.4 | 0.8 | 1.0 | 3.0 | 6.0 | 10.0 | 15.0 | 20.0 |
| Ar pressure (Pa) | 0.1 | 8.9 | 11.2 | 17.3 | 19.6 | 22.1 | 27.3 | 27.0 | 23.4 | 22.9 |
| when depositing | 0.4 | 7.3 | 13.2 | 16.5 | 20.3 | 21.9 | 27.1 | 27.1 | 24.2 | 23.5 |
| first nonmagnetic | 0.8 | 9.3 | 12.6 | 15.8 | 21.4 | 23.2 | 27.5 | 27.3 | 24.8 | 23.8 |
| underlayer | 1.0 | 5.4 | 9.5 | 13.2 | 19.5 | 21.2 | 27.4 | 27.2 | 24.1 | 21.8 |
| | 3.0 | 5.3 | 9.5 | 11.1 | 15.5 | 17.2 | 18.6 | 18.7 | 16.1 | 14.2 |
| | 6.0 | 6.3 | 8.2 | 12.4 | 14.6 | 14.6 | 16.2 | 17.1 | 15.7 | 15.0 |
| | 10.0 | 5.3 | 7.3 | 10.8 | 13.2 | 16.1 | 16.0 | 16.5 | 14.2 | 13.4 |
| | 15.0 | 4.5 | 6.6 | 10.7 | 13.7 | 14.6 | 15.7 | 16.3 | 15.2 | 12.8 |
| | 20.0 | 2.5 | 5.5 | 9.2 | 12.8 | 12.6 | 13.2 | 11.6 | 10.5 | 8.2 |

As shown in Table 2, the recording/reproduction characteristics were good when the first nonmagnetic underlayer was deposited at an Ar pressure of 0.1 to 1.0 Pa and the second nonmagnetic underlayer was deposited at an Ar pressure of 6.0 to 10.0 Pa.

### Example 3

Magnetic recording media of Example 3 were manufactured following the same procedures as in Example 1 except that various composition ratios were used as a nonmagnetic template layer.

Table 3 below shows the evaluation results of the magnetic recording media of Example 3.

TABLE 3

| | Ru-x at % Si | | | | | | | | |
|---|---|---|---|---|---|---|---|---|---|
| | 0 | 5 | 10 | 20 | 30 | 40 | 50 | 60 | 70 |
| SNR(dB) | 22.4 | 24.8 | 27.2 | 27.5 | 27.8 | 27.4 | 19.2 | 15.1 | 10.8 |

As shown in Table 3, favorable recording/reproduction characteristics were obtained when the Si composition of Ru—Si was 10 to 40 at % in the nonmagnetic template layer.

### Example 4

Magnetic recording media of Example 4 were manufactured following the same procedures as in Example 1 except that Ru-30 at % Cr was used as one or both of first and second nonmagnetic underlayers.

Table 4 below shows the evaluation results of the magnetic recording media of Example 4 and Comparative Example 1.

TABLE 4

| | First | Second | |
|---|---|---|---|
| | nonmagnetic | nonmagnetic | SNR |
| | underlayer | underlayer | (dB) |
| Example 4-1 | Ru | Ru-30 at % Cr | 26.5 |
| Example 4-2 | Ru-30 at % Cr | Ru | 26.8 |
| Example 4-3 | Ru-30 at % Cr | Ru-30 at % Cr | 26.1 |
| Comparative | Ru | Ru | 22.1 |
| Example 1 | | | |

As shown in Table 4, favorable recording/reproduction characteristics were obtained even when using Ru-30 at % Cr as the first and second nonmagnetic underlayers.

### Example 5

Magnetic recording media of Example 5 were manufactured following the same procedures as in Example 1 except that Ru-20 at % Si films having various thicknesses were used as nonmagnetic template layers.

Table 5 below shows the evaluation results of the magnetic recording media of Example 5.

TABLE 5

| | Thickness (nm) of Ru-20 at % Si | | | | | | | | |
|---|---|---|---|---|---|---|---|---|---|
| | 0 | 1 | 2 | 3 | 4 | 5 | 6 | 7 | 8 |
| SNR(dB) | 22.1 | 26.8 | 27.2 | 27.5 | 26.8 | 26.1 | 18.1 | 14.9 | 13.2 |

As shown in Table 5, favorable recording/reproduction characteristics were obtained when using Ru-20 at % Si having a thickness of 1 to 5 nm as the nonmagnetic template layer 11.

### Example 6

A magnetic recording medium of Example 6 was manufactured following the same procedures as in Example 1 except that a 5-nm-thick Si layer and 5-nm-thick Pd layer were used as orientation control layers instead of the NiW layer.

Table 6 below shows the evaluation results of the magnetic recording media of Examples 1 and 6 and Comparative Example 1.

TABLE 6

| | | First | | Second | | |
|---|---|---|---|---|---|---|
| | Orientation | nonmagnetic | Nonmagnetic | nonmagnetic | SNR | Standard |
| | control layer | underlayer | template layer | underlayer | (dB) | deviation (%) |
| Example 1 | NiW | Ru | Ru—20%Si | Ru | 27.5 | 14 |
| Example 6 | Si/Pd | Ru | Ru—20%Si | Ru | 28.1 | 12 |
| Comparative | NiW | Ru | — | Ru | 22.1 | 21 |
| Example 1 | | | | | | |

As shown in Table 6, favorable recording/reproduction characteristics were obtained when using the Si layer and Pd layer as the orientation control layer.

### Example 7

Magnetic recording media of Example 7 were manufactured following the same procedures as in Example 1 except that various oxides were used instead of SiO₂ as additives of a first perpendicular magnetic recording layer. In addition, a magnetic recording medium of Comparative Example 13 was manufactured following the same procedures as in Example 1 except that no oxide was used.

Table 7 below shows the evaluation results of the magnetic recording media of Examples 1 and 7 and Comparative Example 13.

TABLE 7

| | First perpendicular | |
|---|---|---|
| | magnetic recording layer | SNR (dB) |
| Example 1 | Co-20 at % Cr-18 at % | 27.5 |
| | Pt-10 mol % SiO₂ | |
| Example 7-1 | Co-20 at % Cr-18 at % | 27.4 |
| | Pt-10 mol % TiO₂ | |
| Example 7-2 | Co-20 at % Cr-18 at % | 25.9 |
| | Pt-10 mol % Cr₂O₃ | |
| Example 7-3 | Co-20 at % Cr-18 at % | 27.6 |
| | Pt-5 mol % Cr₂O₃-5 mol % TiO₂ | |
| Comparative | Co-20 at % Cr-18 at % Pt | 15.1 |
| Example 13 | | |

As shown in Table 7, favorable recording/reproduction characteristics were obtained when using SiO₂, TiO₂, and Cr₂O₃ as the oxide of the recording layer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a nonmagnetic substrate;
at least one soft magnetic layer on the nonmagnetic substrate;
a first nonmagnetic underlayer on the soft magnetic layer and comprising one of ruthenium and a first ruthenium alloy sputtered in an inert gas ambient;
a nonmagnetic template layer on the first nonmagnetic underlayer and comprising ruthenium and silicon;
a second nonmagnetic underlayer on the nonmagnetic template layer and comprising one of ruthenium and a second ruthenium alloy sputtered in an inert gas ambient at a pressure higher than a pressure during sputtering the first nonmagnetic underlayer; and
a perpendicular magnetic recording layer on the second nonmagnetic underlayer.

2. The medium of claim 1, wherein the nonmagnetic template layer has a thickness of 1 to 5 nm.

3. The medium of claim 1, wherein the nonmagnetic template layer comprises 10 to 40 at % of silicon.

4. The medium of claim 1, further comprising an orientation control layer comprising a silicon compound between the soft magnetic layer and the first nonmagnetic underlayer.

5. The medium of claim 1, wherein at least one of the first nonmagnetic underlayer and the second nonmagnetic underlayer comprises one of ruthenium and a ruthenium-chromium alloy.

6. The medium of claim 1, wherein the perpendicular magnetic recording layer comprises cobalt, platinum, chromium, and a silicon oxide, a chromium oxide, a titanium oxide, or a combination thereof.

7. The medium of claim 1, wherein a standard deviation of grain size distribution of crystal grains is equal to or less than 20% in the second nonmagnetic underlayer and the perpendicular magnetic recording layer.

8. The medium of claim 1, wherein a pressure during sputtering the first nonmagnetic underlayer is 0.1 to 1.0 Pa, and a pressure during sputtering the second nonmagnetic underlayer is 6.0 to 10.0 Pa.

9. The medium of claim 1, wherein the inert gas is selected from the group consisting of argon, neon, krypton, and xenon.

10. The medium of claim 1, wherein the first ruthenium alloy comprises at least one alloy selected from the group consisting of ruthenium-chromium (Ru—Cr), ruthenium-cobalt (Ru—Co), ruthenium-manganese (Ru—Mn), ruthenium-silicon dioxide (Ru—SiO₂), ruthenium-titanium dioxide (Ru—TiO₂), ruthenium-titanium oxide (Ru—TiOₓ), ruthenium-boron (Ru—B), and ruthenium-carbon (Ru—C).

11. The medium of claim 1, wherein the second ruthenium alloy comprises at least one alloy selected from the group consisting of Ru—Cr, Ru—Co, Ru—Mn, Ru—SiO₂, Ru—TiO₂, Ru—TiOₓ, Ru—B, and Ru—C.

12. A magnetic recording/reproduction apparatus comprising:
a perpendicular magnetic recording medium comprising a nonmagnetic substrate, at least one soft magnetic layer on the nonmagnetic substrate, a first nonmagnetic underlayer on the soft magnetic layer and comprising one of ruthenium and a first ruthenium alloy sputtered in an inert gas ambient, a nonmagnetic template layer on the first nonmagnetic underlayer and comprising ruthenium and silicon, a second nonmagnetic underlayer on the nonmagnetic template layer and comprising one of ruthenium and a second ruthenium alloy sputtered in an inert gas ambient at a pressure higher than a pressure during sputtering the first nonmagnetic underlayer, and a perpendicular magnetic recording layer on the second nonmagnetic underlayer;
a spindle configured to support and rotate the perpendicular magnetic recording medium;
a magnetic head comprising a writer configured to record information on the perpendicular magnetic recording medium, and a reader which reproduces recorded information; and
a carriage assembly configured to support the magnetic head in such a manner that the magnetic head is configured to move over the perpendicular magnetic recording medium.

13. The apparatus of claim 12, wherein the nonmagnetic template layer has a thickness of 1 to 5 nm.

14. The apparatus of claim 12, wherein the nonmagnetic template layer comprises 10 to 40 at % of silicon.

15. The apparatus of claim 12, further comprising an orientation control layer comprising a silicon compound between the soft magnetic layer and the first nonmagnetic underlayer.

16. The apparatus of claim 12, wherein at least one of the first nonmagnetic underlayer and the second nonmagnetic underlayer comprises one of ruthenium and a ruthenium-chromium alloy.

17. The apparatus of claim 12, wherein the perpendicular magnetic recording layer comprises cobalt, platinum, chromium, and at least one of a silicon oxide, a chromium oxide, and a titanium oxide.

18. The apparatus of claim 12, wherein a standard deviation of grain size distribution of crystal grains is equal to or less than 20% in the second nonmagnetic underlayer and the perpendicular magnetic recording layer.

19. The apparatus of claim 12, wherein a pressure during sputtering the first nonmagnetic underlayer is 0.1 to 1.0 Pa, and a pressure during sputtering the second nonmagnetic underlayer is 6.0 to 10.0 Pa.

20. The apparatus of claim 12, wherein the inert gas is selected from the group consisting of argon, neon, krypton, and xenon.

21. The apparatus of claim 12, wherein the first ruthenium alloy is at least one alloy selected from the group consisting of Ru—Cr, Ru—Co, Ru—Mn, Ru—SiO₂, Ru—TiO₂, Ru—TiOₓ, Ru—B, and Ru—C.

22. The apparatus of claim 12, wherein the second ruthenium alloy is at least one alloy selected from the group consisting of Ru—Cr, Ru—Co, Ru—Mn, Ru—SiO₂, Ru—TiO₂, Ru—TiOₓ, Ru—B, and Ru—C.
